(19) United States
(12) Patent Application Publication
(10) Pub. No.: US 2007/0260579 A1
(43) Pub. Date: Nov. 8, 2007

(54) METHOD OF DESIGNING QUERY CLASSIFICATION COMPONENT FOR MULTILEVEL DBMS

(75) Inventors: Hae Young BAE, Incheon (KR); Gyoung Bae KIM, Daejon (KR); Ho Seok KIM, Gyeonggi-do (KR); Yong Il JANG, Incheon (KR); Byeong Seob YOU, Gyeonggi-do (KR); Sang Hun EO, Seoul (KR); Dong Wook LEE, Seoul (KR); Seok Kyu JANG, Gangwon-do (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: INHA-INDUSTRY PARTNERSHIP INSTITUTE, Incheon (KR)

(21) Appl. No.: 11/554,066

(22) Filed: Oct. 30, 2006

(30) Foreign Application Priority Data
May 2, 2006 (KR) 10-2006-0039500

(51) Int. Cl. G06F 17/30

(52) U.S. Cl. 707/2

(57) ABSTRACT

Disclosed herein is a method of designing a query classificaton component for a multilevel DataBase Management System (DBMS). The method includes determining whether a plan tree, which is used for query processing, is input; if the plan tree is input, designing the query classification component to output locations for respective tables, at which data must be referenced in conjunction with the plan tree, and corresponding predicates; and transferring the locations for respective tables and the corresponding predicates to respective storage managers and causing each of the storage managers to process corresponding data.

### BACKGROUND OF THE INVENTION

1. Field of the Invention

The present invention relates generally to a method of designing a query classification component for a multilevel database management system and, more particularly, to a method of designing a query classification component for a multilevel DBMS, which designs and implements the query classificaton component for the multilevel database management system to provide location-based service, such as ‘tracking’ and ‘finding friends’, using information about users' locations provided by mobile devices, such as mobile phones and personal digital assistants, thus satisfying the demand for fast processing of transactions.

2. Description of the Related Art

Generally, Location-Based Service (LBS), such as ‘tracking’ and ‘finding friends,’ using information about users' locations provided by mobile devices, such as mobile phones and Personal Digital Assistants (PDAs), is provided to a great number of users at the same time, therefore a database system that is capable of rapidly processing many transactions is required.

Currently, in order to support LBS, for which the processing of a large volume of location data is required as described above, temporal and spatial database systems or moving object database systems are clustered and used.

However, the above-described systems are based on a communication method using a network, and fundamental measures for network faults or network cost must be considered.

Accordingly, if each of the database systems constituting an entire system can not only support the faster processing of transactions but also manage a large volume of data, a large volume of service can be supported using a cluster system composed of a small number of nodes. In other words, when the nodes constituting a cluster system are replaced with a high-performance multilevel DBMS, a large volume of service can be supported using a cluster system composed of a small number of nodes.

A multilevel DBMS is a DBMS using a plurality of storage devices, having different access speeds and different storage capacities, and meets requirements for the fast processing and management of a large volume of data. A part of a vast amount of data, for which very fast operations are required, is managed in the main memory database of this system, and the remaining part of data is stably managed in the disk database thereof. Accordingly, one multilevel DBMS is suitable for a single node having the best performance in a database cluster system.

However, in a typical multilevel DBMS, pieces of data that are stored in respective databases in different levels are independent of each other. Accordingly, in order to access lower-level data, the lower-level data must be moved to a buffer space and used. That is, data that is already stored in each disk database must necessarily be read into the buffer space of a memory region. Accordingly, a problem occurs in that a considerable cost is required for Input/Output (I/O) between levels.

### SUMMARY OF THE INVENTION

Accordingly, the present invention has been made keeping in mind the above problems occurring in the prior art, and an object of the present invention is to provide a method of designing a query classification component for a multilevel DBMS, which creates in advance snapshots of pieces of data for which fast searching is required, in a main memory database and allows the snapshots to be used.

Another object of the present invention is to provide a method of designing a query classification component for a multilevel DBMS, which can support the very fast processing of a large number of transactions without incurring a cost for I/O using the snapshots created in the main memory database.

In order to accomplish the above object, the present invention provides a method of designing a query classificaton component for a DBMS, the method including the steps of determining whether a plan tree, which is used for query processing, is input; if the plan tree is input, designing the query classification component to output locations for respective tables, at which data must be referenced in conjunction with the plan tree, and corresponding predicates; and transferring the locations for respective tables and the corresponding predicates to respective storage managers and causing each of the storage managers to process corresponding data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a multilevel DBMS having snapshots according to the present invention;

FIG. 2 is a block diagram showing a multilevel DBMS having snapshots for LBS according to the present invention;

FIG. 3 is a flowchart illustrating a method of designing a query classification component for a multilevel DBMS according to the present invention;

FIG. 4 is a flowchart illustrating a query decision routine applied to FIG. 3;

FIG. 5 is a flowchart illustrating a plan tree traverse routine applied to FIG. 4;

FIGS. 6A and 6B are flowcharts illustrating the level decision routine of a table applied to FIG. 5;

FIG. 7 is a flowchart illustrating a field division routine applied to FIGS. 6A and 6B;

FIG. 8 is a flowchart illustrating an aspatial division routine applied to FIGS. 6A and 6B;

FIG. 9 is a flowchart illustrating a spatial division routine applied to FIGS. 6A and 6B; and

FIGS. 10A and 10B are flowcharts illustrating a divided predicate creation routine applied to FIGS. 6A and 6B.

### DESCRIPTION OF THE PREFERRED EMBODIMENTS

An embodiment of the present invention is described in detail with reference to the accompanying drawings.

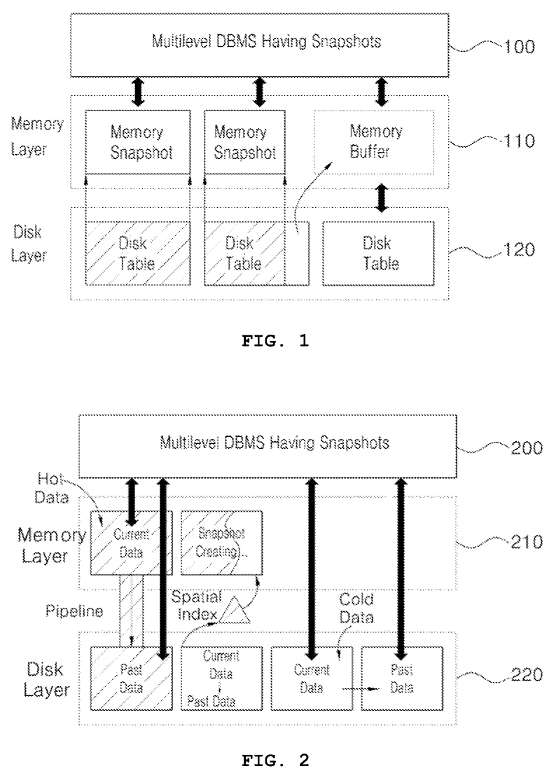

FIG. 1 is a block diagram showing a multilevel DBMS having snapshots according to the present invention. As shown in FIG. 1, the multilevel DBMS having snapshots includes a disk-based database and a memory-based database. All pieces of data are present in a lower level disk layer 120, and data for which fast processing is required is present in an upper level memory layer 110 in a snapshot form. This means that the pieces of data in the respective layers are not independent of each other. Furthermore, the disk-based database is used as a back-up storage device, so that a memory routine may be used to process snapshots stored in the upper layer 110 without taking the restoration of data into account.

FIG. 2 is a block diagram showing a multilevel DBMS having snapshots for LBS according to the present invention.

As shown in FIG. 2, the multilevel DBMS having snapshots for LBS is constructed such that hot data for which fast processing is required can be managed as current data in memory 210 using snapshots, and past data is realized so as to be managed on a disk 220. In contrast, cold data, for which fast processing is not required, but which has a large volume, is realized to enable both the current data and the past data to be managed on the disk 220, uses the current data, which is being managed on the disk 220, when a snapshot is created, and is created in the memory 210, along with snapshot indices for managing moving objects, during creation. Data created by snapshot is stored in the overall or partial region of a single table using a predicate, along with spatial data and aspatial data.

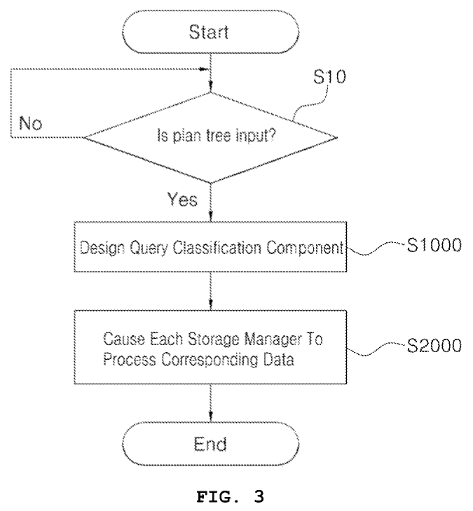

A method of designing a query classificaton component for the multilevel DBMS having snapshots, which is constructed as described above, is described with reference to the accompanying drawings below. FIG. 3 is a flowchart illustrating a method of designing a query classification component for the multilevel DBMS according to the present invention.

With reference to FIG. 3, the method of designing a query classification component for the multilevel DBMS is described. First, it is determined whether a plan tree, which is used to process a query, is input at step S10. If, as a result of the determination, the plan tree is input, a query classification component is designed to output locations for respective tables, at which data must be referenced in conjunction with the plan tree, and corresponding predicates at step S1000. The locations for respective tables and the corresponding predicates, which are output through the step S1000 of designing the query classification component, are transferred to respective storage managers, and corresponding data is processed by each of the storage managers at step S2000.

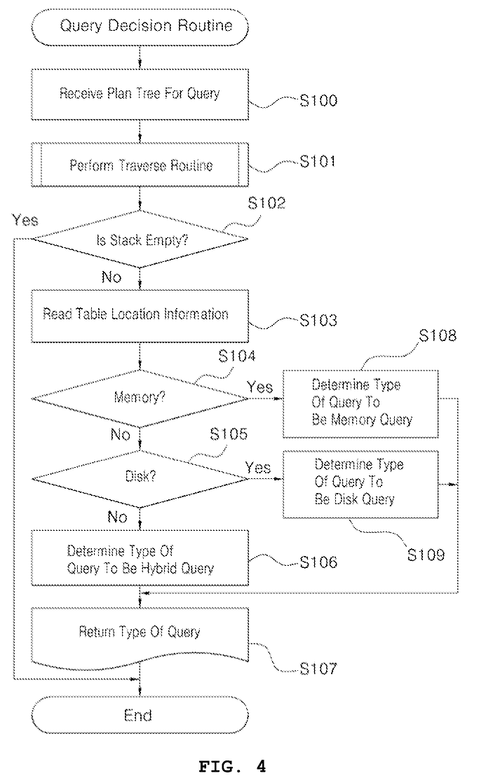

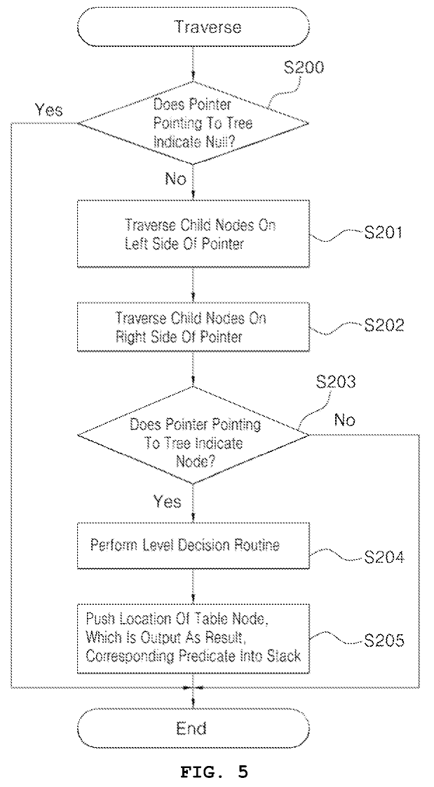

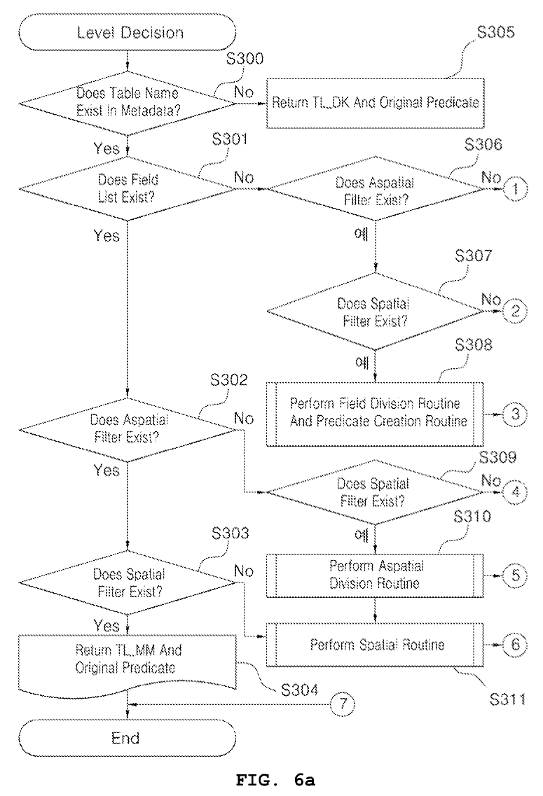

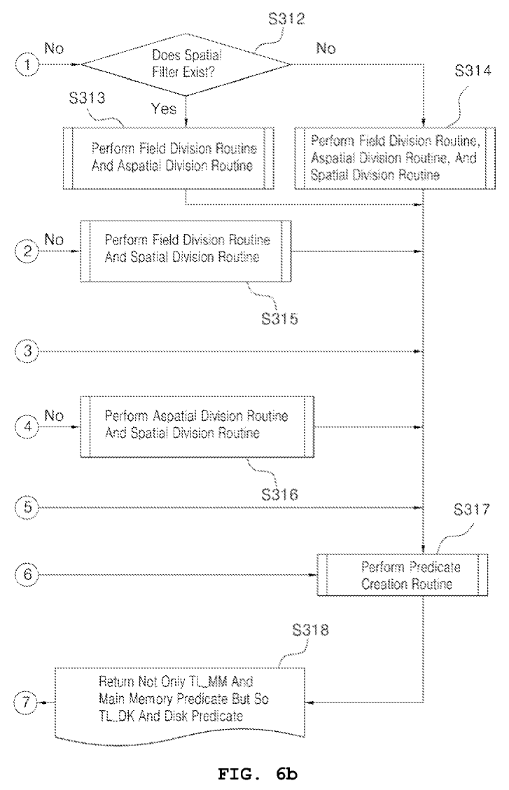

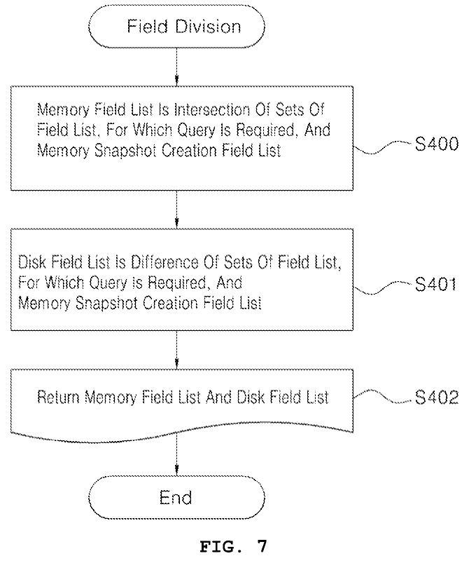

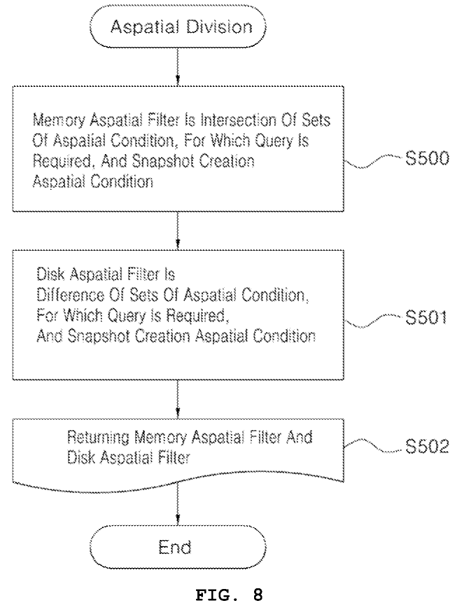

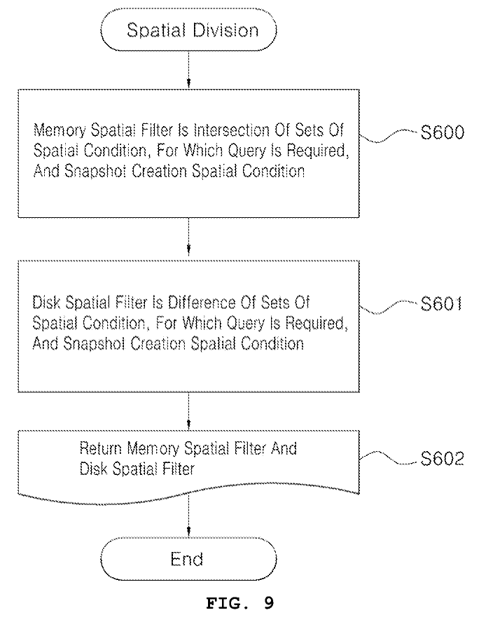

In this case, the step S10000 of designing a query classification component is performed through the query decision routine of FIG. 4, the plan tree traverse routine of FIG. 5, the level decision routine of FIG. 6, the field division routine of FIG. 7, the aspatial division routine of FIG. 8, the spatial division routine of FIG. 9, and the divided predicate creation routine of FIG. 9, which will be described later.

FIG. 4 is a flowchart illustrating the query decision routine applied to FIG. 3.

Referring to FIG. 4, the query decision routine in the multilevel DBMS having snapshots according to the present invention receives a plan tree at step S100.

Thereafter, after the plan tree has been received at step 100, whether a stack is empty is determined at step S102 while a plan tee traverse routine is performed at step 110. If, as a result of the determination, the stack is determined to be empty ‘yes’ at step S102), the query decision routine is terminated. In contrast, if, as a result of the determination, the stack is determined not to be empty (‘no’ at step S102), pieces of information about the locations for respective tables, which is already inserted into the stack, are read at step S103 and, thereafter, whether all of the read pieces of information about the location for respective tables indicate memory is determined at step S104.

If, as a result of the determination at step S104, all of the read pieces of information are determined to indicate memory, the type of query is determined to be a memory query TQ_MM at step S108. In contrast, if, as a result of the determination, all of the read pieces of information are determined not to indicate memory, whether all of the read pieces of information about the location for respective indicate a disk is determined at step S105.

If, as a result of the determination at step S105, all of the read pieces of information are determined to indicate a disk, the type of query is determined to be a disk query TQ_DK at step S109. In contrast, if, as a result of the determination, all of the read pieces of information are determined not to indicate a disk, the type of query is determined to be a hybrid query TQ_HB at step S106, and then information about the type of query is returned at step S107.

That is, the above-described query decision routine receives a plan tree and then returns information about the type of query. This routine functions to determine the type of query by fetching and parsing the locations for respective tables, which are already inserted into the stack, while traversing the plan tree. The stack includes corresponding predicates, along with the locations for respective tables, therein. Accordingly, the type of query can be determined and, at the same time, desired data can be fetched from memory or disks using the corresponding predicates.

FIG. 5 is a flowchart illustrating a plan tree traverse routine applied to FIG. 4.

FIG. 5 is a diagram illustrating the plan tree traverse routine in the multilevel DBMS having snapshots according to the present invention. The plan tree traverse routine determines whether a pointer pointing to a tree indicates null at step S200. If, as a result of the determination, the pointer is determined to indicate null, the plan tree traverse routine is terminated. In contrast, if, as a result of the determination, the pointer is determined not to indicate null, child nodes on the left side of the pointer are traversed at step S201.

After the step S201 has been performed, child nodes on the right side of the pointer are traversed at step S202. After the step S202 of traversing the right child nodes has been performed as described above, whether the pointer pointing to a tree indicates a table node is determined at step S203.

If, as a result of the determination, the pointer is determined to indicate the table node, a level decision routine is performed at step S204. The location of the table node and a corresponding predicate, which are output as the results of the performance, are pushed into the stack at step S205, and then the plan tree traverse routine is terminated.

In contrast, if, as a result of the determination at the step 203, the pointer is determined not to indicate the table node, the plan tree traverse routine is terminated.

That is, the plan tree traverse routine is performed in such as way as to receive a stack in which results, along with the plan tree, are stored, call a level decision function when encountering a table node while the plan tree is traversed in postorder, push predicate information, along with all the table-based locations, into the stack after the traverse has been completed, and be then terminated.

FIGS. 6A and 6B are flowcharts illustrating the level decision routine of a table applied to FIG. 5.

FIGS. 6A and 6B are diagrams illustrating the level decision routine in the DBMS having snapshots according to the present invention. First, the level decision routine determines whether a table name exists in metadata at step S300.

If, as a result of the determination at step S300, the table name is determined to exist in the metadata, whether a field list exists in the metadata is determined at step S302. If, as a result of the determination, the field list is determined to exist in the metadata, whether an aspatial filter name exists in the metadata is determined at step S302.

If, as a result of the determination at step S302, the aspatial filter name exists in the metadata, whether a spatial field name exists in the metadata is determined at step S303. If, as a result of the determination, the spatial filter name exists, it is determined that data necessary to perform operations can be fetched from memory snapshots, and then a required original predicate, along with TL_MM, is returned at step S304.

Meanwhile, if, as a result of the determination at step S300, the table name does not exist in the metadata, a required original predicate, along with TL_DK, is returned at step S305.

Meanwhile, if, as a result of the determination at step S301, the field list is determined not to exist in the metadata, whether an aspatial filter name exists in the metadata is determined at step S306. If, a result of the determination, the aspatial filter name is determined to exist in the metadata, whether a spatial filter name exists in the metadata is determined at step S307.

If, as a result of the determination at step 307, the spatial filter name is determined to exist in the metadata, the field division routine and the divided predicate creation routine are sequentially performed at steps S308 and S317.

Meanwhile, if, as a result of the determination at step 302, the aspatial filter name is determined not to exist in the metadata, whether an aspatial filter name exists in the metadata is determined at step S309. If, as a result of the determination, the aspatial filter name is determined to exist in the metadata, TL_MM and a main memory predicate are returned after the aspatial division routine at step S310 and the divided predicate creation routine at step S317 have been sequentially performed, a required disk predicate, along with TL_DK, is returned at step S318, and the level decision routine is terminated.

Meanwhile, if, as a result of the determination at step S303, the spatial filter name is determined not to exist in the metadata, TL_MM and the main memory predicate are returned after the spatial division routine at step S311 and the divided predicate creation routine at step S317 have been sequentially performed, the required disk predicate, along with TL_DK, is returned at step S318, and the level decision routine is terminated.

Meanwhile, if, as a result of the determination at step 306, the aspatial filter name is determined not to exist in the metadata, whether a spatial filter name exists in the metadata is determined at step S312. If, as a result of the determination, the spatial filter name is determined to exist in the metadata, TL_MM and the main memory predicate are returned after the field division routine and the aspatial division routine at step 313 and the divided predicate creation routine at step S317 have been sequentially performed, the required disk predicate, along with TL_DK, is returned at step S318, and the level decision routine is terminated.

Meanwhile, if, as a result of the determination at step 312, the spatial filter name is determined not to exist in the metadata, TL_MM and the main memory predicate are returned after the field division routine, the aspatial division routine and the spatial division routine at step S314 and the divided predicate creation routine at step S317 have been sequentially performed, the required disk predicate, along with TL_DK, is returned at step S318, and the level decision routine is terminated.

That is, the level decision routine functions to receive a table, which is one node of the plan tree, and determine the predicate of the corresponding table as well as the location thereof.

Whether a table name exists in the metadata is determined from the first conditional sentence at step S300 and then whether a required field list exists in the plan tree is determined from the second conditional sentence at step S301. Whether a condition in which the aspatial and spatial resigns of required data are written in the metadata is included in the plan tree is determined from the third conditional sentence at steps S302 and S306 and from the fourth conditional sentence at steps S303 and S312. Accordingly, when all of the four conditions are satisfied, it is determined that data required for operation can be fetched from the memory snapshots, and then a required original predicate, along with TL_MM, is returned. However, even when one among the four conditions is not satisfied, the required original predicate, along with TL_DK, is returned.

FIG. 7 is a flowchart illustrating the field division routine applied to FIGS. 6A and 6B.

As shown in FIG. 7, if a memory field list ‘MMFieldList’ is the intersection of sets of a field list QF, for which a query is required, and if a memory snapshot creation field list SF at step S400, and a disk field list ‘DKFieldList’ is the difference of sets of the field list QF, for which a query is required, and the memory snapshot creation field list SF at step S401, the field list division routine returns the memory field list and the disk field list at step S402, and is then terminated. That is, the field division routine is a routine that allows the field list, for which a query is required, and a field list, which is possessed by a snapshot, to be divided into a portion, which can be processed in memory, and a portion, which can be processed on a disk. A memory region is the intersection of sets of the query field list and the snapshot field list, and a disk region is a portion obtained by the subtraction of the snapshot field list from the query field list.

FIG. 8 is a flowchart illustrating the aspatial division routine applied to FIGS. 6A and 6B.

As shown in FIG. 8, if a memory aspatial filter ‘MMAFilter’ is the intersection of sets of an aspatial condition QA, for which a query is required, and if a snapshot creation aspatial condition SA at step S500, and a disk aspatial filter ‘DKAFilter’ is the difference of sets of the aspatial condition QA, for which a query is required, and the snapshot creation aspatial condition SA at step S501, the aspatial division routine returns the memory aspatial filter and the disk aspatial filter at step 502 and is then terminated.

That is, the aspatial division routine is a routine that allows the aspatial filter condition, for which a query is required, and the aspatial filter condition, which is possessed in a snapshot, to be divided into a condition, which can be processed in memory, and a condition, which can be processed on a disk. A memory region is the intersection of sets of the query filter condition and the snapshot filter condition, and a disk region is a portion obtained by the subtraction of the snapshot filter condition from the query filter condition.

FIG. 9 is a flowchart illustrating a spatial division routine applied to FIGS. 6A and 6B.

As shown in FIG. 9, if a memory spatial filter ‘MMSFilter’ is the intersection of sets of a spatial condition SA, for which a query is required, and a snapshot creation spatial condition SS at step S600, and if a disk spatial filter ‘DKSFilter’ is the difference of sets of the spatial condition SA for which a query is required, and the snapshot creation spatial condition SS at step S601, the spatial division routine returns the memory spatial filter and the disk spatial filter at step S602 and is then terminated.

That is, the spatial division routine is a routine that allows a spatial region, for which a query is required, and a spatial region, which is possessed in a snapshot, to be divided into a portion, which can be processed in memory, and a portion, which can be processed on a disk. A memory region is the intersection of sets of the query region and the snapshot region, and a disk region is a portion obtained by the subtraction of the snapshot region from the query region.

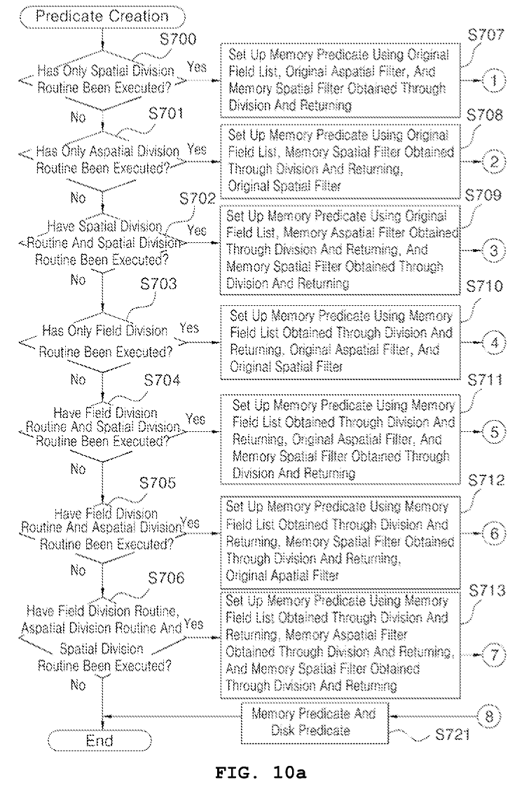

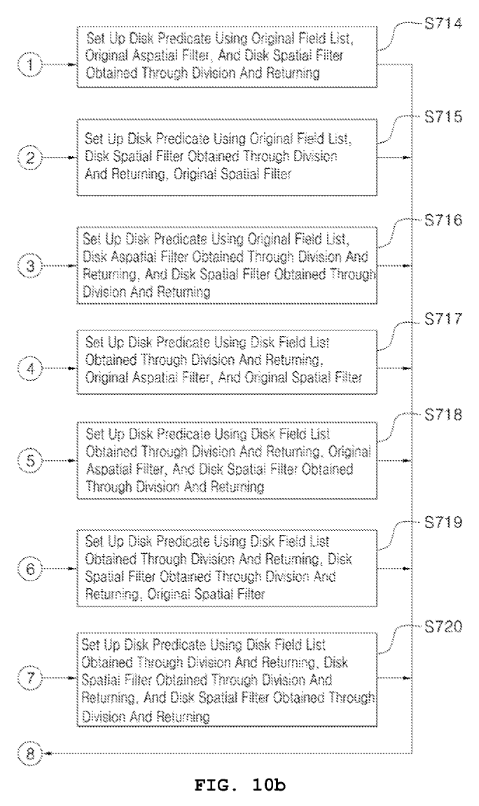

FIGS. 10A and 10B are flowcharts illustrating a divided predicate creation routine applied to FIGS. 6A and 6B.

Referring to FIGS. 10A and 10B, first, the divided predicate creation routine determines whether only the spatial filter division routine has been executed at step S700. If, as a result of the determination, only the spatial filter division routine is determined to have been executed, the memory predicate is set up using an original field list, an original aspatial filter, and a memory spatial filter obtained through the division and return, at step S707. Thereafter, the memory predicate is set up using an original field list, an original aspatial filter, and a disk spatial filter obtained through division and returning, at step S714.

Meanwhile, if, as a result of the determination at step S700, only the spatial filter division routine is determined not to have been executed, whether only the aspatial division routine is executed is determined at step S701. If, as a result of the determination, only the aspatial filter division routine has been executed, the memory predicate is set up using an original field list, a memory aspatial filter obtained through division and returning, and an original memory spatial filter at step S708. Thereafter, the disk predicate is set up using an original field list, a disk aspatial filter obtained through division and returning, and an original disk spatial filter at step S715.

Meanwhile, if, as a result of the determination at step S701, only the aspatial filter division routine is determined not to have been executed, whether the spatial filter division routine and the aspatial filter division routine have been executed is determined at step S702. If, as a result of the determination, the spatial division routine and the aspatial filter division routine are determined to have been executed, the memory predicate is set up using an original field list, a memory aspatial filter obtained through division and returning, and a memory spatial filter obtained through division and returning, at step S709. Thereafter, the disk predicate is set up using an original field list, a disk aspatial filter obtained through division and returning, and a disk spatial filter obtained through division and returning, at step S716.

Meanwhile, if, as a result of the determination at step S702, the spatial filter division and the aspatial filter division routine are determined not to have been executed, whether only the field division routine has been executed is determined at step S703. If, as a result of the determination, only the field division routine is determined to have been executed, the memory predicate is set up using a memory field list obtained through division and returning, an original aspatial filter, and an original spatial filter at step S710. Thereafter, the disk predicate is set up using a field list obtained through division and returning, an original aspatial filter, and an original spatial filter at step S717.

Meanwhile, if, as a result of the determination at step S703, only the field division routine is determined not to have been executed, whether the field division routine and the spatial division routine have been executed is determined at step S704. If, as a result of the determination, the field division routine and the spatial division routine are determined to have been executed, the memory predicate is set up using a memory field list obtained through division and returning, an original aspatial filter, and a memory spatial filter obtained through division and returning, at step S711. Thereafter, the disk predicate is set up using a field list obtained through division and returning, an original aspatial filter, and a disk spatial filter obtained through division and returning, at step S718.

Meanwhile, if, as a result of the determination at step S704, the field division routine and the spatial division routine are determined not to have been executed, whether the field division routine and the aspatial division routine have been executed is determined at step S705. If, as a result of the determination, the field division routine and the aspatial division routine are determined not to have been executed, the memory predicate is set up using a memory field list obtained through division and returning, a memory aspatial filter obtained through division and returning, and an original spatial filter at step S712. Thereafter, the disk predicate is set up using a field list obtained through division and returning, a disk aspatial filter obtained through division and returning, and an original spatial filter at step S719.

Meanwhile, if, as a result of the determination at step S705, the field division routine and the aspatial division routine are determined not to have been executed, whether the field division routine, the aspatial division routine and the spatial division routine have been executed is determined at step S706. If, as a result of the determination, the field division routine, the aspatial division routine and the spatial division routine are determined to have been executed, the memory predicate is set up using a memory field list obtained through division and returning, a memory aspatial filter obtained through division and returning, and a memory spatial filter obtained through division and returning, at step S713. Thereafter, the disk predicate is set up using a field list obtained through division and returning, a disk aspatial filter obtained through division and returning, and a disk spatial filter obtained through division and returning, at step S720.

Thereafter, when, at step S721, the memory predicate and the disk predicate are returned after the steps S714, S715, S716, S717, S718, S719 and S720 have been performed, the predicate creation routine is terminated.

That is, the divided predicate creation routine is a routine that allows respective predicates, which use memory and a disk, to be set. For seven cases obtained by subtracting one case, which satisfies all the conditions, from the eight cases, which are determined by the level decision routine, a combination of the field list, the aspatial filter, and the spatial filter is made for respective disks and respective pieces of memory, and new predicates are created.

As described above, the present invention enables the design and development of a query classification component that enables snapshots, which are already created in a memory database, to be maximally used in the multilevel DBMS having snapshots. The query classification component classifies input queries into a memory query type, a disk query type, and a hybrid query type, and processes the queries. Particularly, in the hybrid query type, in order to maximally use memory data, the predicates of the input queries are divided into a memory part and a disk part and are then processed, so that the rate of use of snapshots increases.

The proposed query classificaton component is disadvantageous in that the case of the memory or disk query requires somewhat more time than the case processed without a query due to the accompanying load at the time of use of the query division routine. However, when the multilevel DBMS having snapshots is established in a general LBS environment, the hybrid queries are chiefly processed, so that a faster response time can be achieved due to the characteristic in which the queries are processed by both disks and memory.

The present invention has a structure similar to an existing multilevel DBMS, but differs from the existing multilevel DBMS in that all pieces of data exist in a lower level disk layer, and data, for which fast processing is required, exists in an upper level memory layer in a snapshot form. That is, pieces of data of respective layers are not independent of each other. Furthermore, the present invention uses a disk-based database as a back-up storage device, so it is advantageous in that, when snapshots stored in the upper layer are processed, a main memory-based routine can be executed in main memory without taking into account problems such as the restoration of data.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method of designing a query classification component for a multilevel DataBase Management System (DBMS), the method comprising the steps of:
determining whether a plan tree, which is used for query processing, is input;
if the plan tree is input, designing the query classificaton component to output locations for respective tables, at which data must be referenced in conjunction with the plan tree, and corresponding predicates; and
transferring the locations for respective tables and the corresponding predicates to respective storage managers and causing each of the storage managers to process corresponding data.

2. The method as set forth in claim 1, wherein the step of designing the query classification component comprises a query decision routine, the query decision routine comprising the steps of:
(1) receiving the plan tree;
(2) determining whether a stack is empty while performing a traverse routine on the received plan tree;
(3) if, as a result of the determination, the stack is determined to be empty, terminating the query decision routine, and if, as a result of the determination, the stack is determined not to be empty, reading pieces of information about the locations for respective tables;
(4) determining whether all of the read pieces of information about the locations for respective tables indicate memory;
(5) if, as a result of the determination, all of the read pieces of information are determined to indicate memory, determining a type of query to be a memory query, and if, as a result of the determination, all of the read pieces of information are determined not to indicate memory, determining whether all of the read pieces of information about the locations for respective tables indicate a disk;
(6) if, as a result of the determination, all of the read pieces of information are determined to indicate a disk, determining the type of query to be a disk query, and if, as a result of the determination, all of the read pieces of information are determined not to indicate a disk, determining the type of query to be a hybrid query and returning information about the type of query.

3. The method as set forth in claim 2, wherein the plan tree traverse routine comprises the steps of:
(2-1) determining whether a pointer pointing to a tree indicates null;
(2-2) if, as a result of the determination, the pointer is determined not to indicate null, traversing child nodes on a left side of the pointer;
(2-3) traversing child nodes on a right side of the pointer after the left child nodes have been traversed;
(2-4) determining whether the pointer pointing to a tree indicates a table node after the right child nodes have been traversed; and
(2-5) if, as a result of the determination, the pointer is determined to indicate the table node, performing a level decision routine and pushing a location of the table node and a corresponding predicate, which are output as results of the performance, into a stack.

4. The method as set forth in claim 3, wherein the level decision routine of step (2-5) comprises the steps of:
(2-4-1) determining whether a table name exists in metadata;
(2-4-2) if, as a result of the determination, the table name is determined to exist, determining whether a field list exists in the metadata;
(2-4-3) if, as a result of the determination, the field list is determined to exist in the metadata, determining whether an aspatial filter name exists in the metadata;
(2-4-4) if, as a result of the determination, the aspatial filter name exists in the metadata, determining whether a spatial field name exists in the metadata; and
(2-4-5) if, as a result of the determination, the spatial filter name is determined to exist in the metadata, determining that data necessary to perform operations can be fetched from memory snapshots and returning a required original predicate, along with TL_MM.

5. The method as set forth in claim 4, wherein the level decision routine of step 2-5 comprises, if, as a result of the determination at step 2-4-1, the table name is determined not to exist in the metadata, the step of returning the required original predicate, along with TL_DK.

6. The method as set forth in claim 4, wherein the level decision routine of step (2-5) comprises the steps of:
(1) if, as a result of the determination at step 2-4-2, the field list is determined not to exist in the metadata, determining whether an aspatial filter name exists in the metadata;
(2) if, a result of the determination, the aspatial filter name is determined to exist in the metadata, determining whether a spatial filter name exists in the metadata; and
(3) if, as a result of the determination, the spatial filter name exists in the metadata, sequentially performing a field division routine and a divided predicate creation routine.

7. The method as set forth in claim 6, wherein the level decision routine of step (2-5) comprises the steps of:
(2-1) if, as a result of the determination at step (2), the aspatial filter name is determined not to exist in the metadata, determining whether an aspatial filter name exists in the metadata; and
(2-2) if, as a result of the determination, the aspatial filter name is determined to exist in the metadata, returning TL_MM and a main memory predicate after an aspatial division routine and the divided predicate creation routine have been sequentially performed, and returning a required disk predicate, along with TL_DK.

8. The method as set forth in claim 4, wherein the level decision routine of step (2-5) comprises, if, as a result of the determination at step (2-4-5), the spatial filter name is determined not to exist in the metadata, the step of returning TL_MM and a main memory predicate after a spatial division routine and a divided predicate creation routine have been sequentially performed, and returning a required disk predicate, along with TL_DK.

9. The method as set forth in claim 6, wherein the level decision routine at step (2-5) comprises the steps of:
if, as a result of the determination at step 2, the aspatial filter name is determined not to exist in the metadata, determining whether a spatial filter name exists in the metadata; and
if, as a result of the determination, the spatial filter name is determined to exist in the metadata, returning TL_MM and a main memory predicate after the field division routine, an aspatial division routine and the divided predicate creation routine have been sequentially performed, and returning a required disk predicate, along with TL_DK.

10. The method as set forth in claim 9, wherein the level decision routine at step (2-5) comprises, if, as a result of the determination, the spatial filter name is determined not to exist in the metadata, the step of returning TL_MM and a main memory predicate after the field division routine, the aspatial division routine, a spatial division routine, and the divided predicate creation routine have been sequentially performed, and returning the required disk predicate, along with TL_DK.

11. The method as set forth in claim 6, 9, or 10, wherein the field division routine returns a memory field list and a disk field list if the memory field list is an intersection of sets of a field list, for which a query is required, and a memory snapshot creation field list, and if the disk field list is a difference of sets of the field list, for which a query is required, and the memory snapshot creation field list.

12. The method as set forth in claim 7, 9, or 10, wherein the aspatial division routine returns a memory aspatial filter and a disk aspatial filter if the memory aspatial filter is an intersection of sets of an aspatial condition, for which a query is required, and a snapshot creation aspatial condition, and if the disk aspatial filter is a difference of sets of the aspatial condition, for which a query is required, and the snapshot creation aspatial condition.

13. The method as set forth in claim 8 or 10, wherein the spatial division routine returns a memory spatial filter and a disk spatial filter if the memory spatial filter is an intersection of sets of a spatial condition, for which a query is required, and a snapshot creation spatial condition, and if the disk spatial filter is a difference of sets of the spatial condition, for which a query is required, and the snapshot creation spatial condition.

14. The method as set forth in any one of claims 6 to 10, wherein the divided predicate creation routine comprises the steps of:
(1) determining whether only the spatial filter division routine has been executed;
(2) if, as a result of the determination, only the spatial filter division routine is determined to have been executed, setting up the memory predicate using an original field list, an original aspatial filter, and a memory spatial filter obtained through division and returning; and
(3) setting up the disk predicate using an original field list, an original aspatial filter, and a disk spatial filter obtained through division and returning, and returning the memory predicate and the disk predicate

15. The method as set forth in claim 14, wherein the predicate creation routine comprises the steps of:
(1-1) if, as a result of the determination at step 1, only the spatial filter division routine is determined not to have been executed, determining whether only the aspatial division routine has been executed;
(1-2) if, as a result of the determination, only the aspatial filter division routine is determined to have been executed, setting up the memory predicate using an original field list, a memory aspatial filter obtained through division and returning, and an original memory spatial filter; and
(1-3) setting up the disk predicate using an original field list, a disk aspatial filter obtained through division and returning, and an original disk spatial filter, and returning the memory predicate and the disk predicate.

16. The method as set forth in claim 15, wherein the predicate creation routine comprises the steps of:
(2-1) if, as a result of the determination at step (1-1), only the aspatial filter division routine is determined not to have been executed, determining whether the spatial filter division routine and the aspatial filter division routine are executed;
(2-2) if, as a result of the determination, the spatial division routine and the aspatial filter division routine are determined to be executed, setting up the memory predicate using an original field list, a memory aspatial filter obtained through division and returning, and a memory spatial filter obtained through division and returning; and
(2-3) setting up the disk predicate using an original field list, a disk aspatial filter obtained through division and returning, and a disk spatial filter obtained through division and returning, and returning the memory predicate and the disk predicate.

17. The method as set forth in claim 16, wherein the predicate creation routine comprises the steps of:
(3-1) if, as a result of the determination at step (2-1), the spatial filter division routine and the aspatial filter division routine are determined to have been executed, determining whether only the field division routine has been executed;
(3-2) if, as a result of the determination, only the field division routine is determined to have been executed, setting up the memory predicate using a memory field list obtained through division and returning, an original aspatial filter, and an original spatial filter; and
(3-3) setting up the disk predicate using a field list obtained through division and returning, an original aspatial filter, and an original spatial filter, and returning the memory predicate and the disk predicate.

18. The method as set forth in claim 17, wherein the predicate creation routine comprises the steps of:
(4-1) if, as a result of the determination at step (3-1), only the field division routine is determined to have been executed, determining whether the field division routine and the spatial division routine have been executed;
(4-2) if, as a result of the determination, the field division routine and the spatial division routine are determined to have been performed, setting up the memory predicate using a memory field list obtained through division and returning, an original aspatial filter, and a memory spatial filter obtained through division and returning; and
(4-3) setting up the disk predicate using a field list obtained through division and returning, an original aspatial filter, and a disk spatial filter obtained through division and returning, and returning the memory predicate and the disk predicate.

19. The method as set forth in claim 18, wherein the predicate creation routine comprises the steps of:
(5-1) if, as a result of the determination at step (4-1), the field division and the spatial division routine are determined not to haven been executed, determining whether the field division and the aspatial division routine have been executed;
(5-2) if, as a result of the determination, the field division routine and the aspatial division routine are determined to have been executed, setting up the memory predicate using a memory field list obtained through division and returning, a memory aspatial filter obtained through division and returning, and an original spatial filter; and
(5-3) setting up the disk predicate using a field list obtained through division and returning, a disk aspatial filter obtained through division and returning, and an original spatial filter, and returning the memory predicate and the disk predicate.

20. The method as set forth in claim 19, wherein the predicate creation routine comprises the steps of:
(6-1) if, as a result of the determination at step (5-1), the field division routine and the aspatial division routine is determined not to have been executed, determining whether the field division routine, the aspatial division routine and the spatial division routine have been executed;
(6-2) if, as a result of the determination, all of the field division routine, the aspatial division routine and the spatial division routine are determined to have been executed, setting up the memory predicate using a memory field list obtained through division and returning, a memory aspatial filter obtained through division and returning, and a memory spatial filter obtained through division and returning; and
(6-3) setting up the disk predicate using a field list obtained through division and returning, a disk aspatial filter obtained through division and returning, and a disk spatial filter obtained through division and returning, and returning the memory predicate and the disk predicate.
